(19) United States
(12) Patent Application Publication
(10) Pub. No.: US 2011/0128813 A1
(43) Pub. Date: Jun. 2, 2011

(54) FLUID MIXER WITH ROTARY SHAFTS AND RELATIVE SEAL UNIT

(76) Inventor: Nunzio D'Orazio, Trevi (IT)

(21) Appl. No.: 12/737,576

(22) PCT Filed: Nov. 26, 2008
(86) PCT No.: PCT/EP2008/066255

§ 371 Date: Jan. 26, 2011

(30) Foreign Application Priority Data
Jul. 31, 2008 (IT) MC2008A000143

(51) Int. Cl. B01F 7/00; B01F 15/00

(52) U.S. Cl. 366/331

(57) ABSTRACT

A fluid mixer comprising a tank designed to contain the fluid to be mixed, a rotary shaft (1) that goes through a hole (22) obtained on the wall (2) of the tank, generating a channel (23) in which the fluid enters from the tank towards a chamber (24) outside the tank, in which the shaft (1) rotates and a seal unit designed to prevent the fluid from seeping out of the chamber (24) is disclosed. The said seal unit comprises a first seal ring (6A) mounted on the rotary shaft (1) and a second seal ring (6B) mounted on a support flange (4) fixed to the wall (2) of the tank, in such a way that the first seal ring (6A) slides in close contact with the second seal ring (6B) preventing the passage of fluid outside the chamber (24).

The present patent application for industrial invention relates to a fluid mixer with rotary shafts provided with seal unit designed to prevent the mixed fluid from seeping. The present invention relates in general to mixers of any type of fluid with adhesive properties that tends to solidify and, in particular, to mixers of concrete, mortar, cement or similar materials.

Mixers of this type normally have a horizontal development and comprise a tank in which the fluid is mixed by means of a double shaft with blades that rotates inside the tank to favour mixing between the elementary components of the product and a multi-directional motion that avoids product agglomerations. The said systems need a double seal system for each rotary shaft.

The perfect retention of the product avoids environmental contamination, which is a very important issue today, and prevents the product processed inside the tank from losing liquid fractions, with loss of quality for the product.

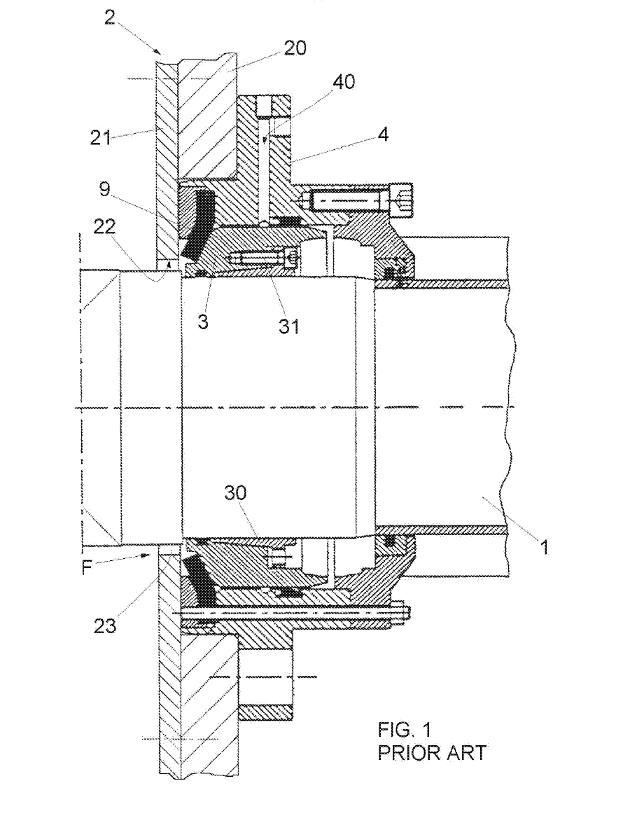

FIG. 1 illustrates a seal unit according to the known technique, which is similar to the one disclosed in patent EP 1 033 165 in the name of O.M.G. The said figure illustrates a rotary shaft (1) with horizontal axis that passes through the wall (2) of a tank that contains the product to be mixed. The wall (2) of the tank comprises a support wall (20) on the outside of the tank and a coating wall (21) on the inside of the tank.

The coating wall (21) is provided with a hole (22) with larger diameter than the external diameter of the shaft (1) to allow for inserting the shaft (1). In view of the above, an annular space is generated between the external surface of the shaft (1) and the perimeter of the hole (22), which defines an inlet channel (23) in which the mixed product penetrates according to the direction indicated by the arrow (F). The function of the seal unit is to prevent the product that enters the inlet channel (23) from seeping.

A metal coupling (3) is coupled to the shaft (1) by means of a conical coupler (30) and screws (31) tightened with a definite torque to join the coupling (3) to the shaft (1).

The coupling (3) is revolvingly mounted on a support flange (4) fitted to the support wall (20) of the tank. In this way the coupling (3) joined to the shaft (1) rotates, being revolvingly supported in the support flange (4). A channel (40) is obtained in the support flange (4) to introduce lubrication grease between the rolling surface of the coupling (3) and the internal surface of the support flange (4). A dosing pump with a grease tank equipped with sequence distributor and relevant grease supply pipes, provides the periodical grease dosage in the system.

The fluid seal is obtained by means of an O-ring (9) fixed in the support flange (4) downstream the inlet channel (23). The O-ring (9) is composed of an elastic element (normally made of polyurethane rubber) that is deformed and slides on a conical part of the coupling (3), preventing the fluid that goes through the inlet channel (23) from seeping.

Nevertheless, this seal system is impaired by numerous disadvantages, due to the management process of the lubrication grease:
a) exhaustion of grease from the tank, with consequent operation without lubrication for some time, damaging the seal system;
b) faulty operation of the distributor, the grease is partially or incorrectly distributed, with consequent damage of the seal system over time;
c) in case of long inactivity of the machine for different reasons, the grease contained in the pipes tends to harden, thus reducing or blocking the grease inflow, with consequent incorrect lubrication and damage to the seal system;
d) regardless of the presence of the O-ring (9), part of the pumped grease is poured inside the tank and mixed with the product; the reduction of wear on the seal edge requires high quantities of lubricant (grease) that finish up mixing with the product and altering its properties.

The purpose of the present invention is to eliminate the drawbacks of the known art, by providing a fluid mixer with rotary shafts equipped with a seal unit characterised by efficiency, reliability and minimum maintenance.

Another purpose of the present invention is to provide a fluid mixer with seal assembly characterised by simple installation and management.

These purposes are achieved by the present invention, whose features are claimed in the independent claim 1.

Advantageous embodiments are disclosed in the dependent claims.

The fluid mixer according to the invention comprises:
a tank used to contain the fluid to be mixed,
a rotary shaft that goes through a hole drilled on the wall of the tank, generating a channel between the external surface of the shaft and the perimeter of the hole of the wall of the tank, in which the fluid enters from the tank towards a chamber outside the tank, in which the shaft rotates, and
a seal unit designed to prevent fluid leakage outside of the chamber.

The seal unit comprises a first seal ring mounted on the rotary shaft and a second seal ring mounted on a support flange fixed to the wall of the tank, in such a way that the first seal ring slides in close contact with the second seal ring, preventing the passage of fluid outside of the chamber.

The advantages of the mixer according to the present invention appear evident, in view of the elimination of the lubrication system.

Advantageously, the seal unit is arranged in such a way to maximise the volume/surface ratio of the chamber that contains the fluid downstream the inlet channel to avoid solidification of the fluid in such a chamber.

Additional characteristics of the invention will appear evident from the following detailed description, which refers to merely illustrative, not limiting embodiments, illustrated in the enclosed drawings, wherein:

FIG. 1 is an axial cross-sectional view of a portion of a fluid mixer with a seal unit according to the known technique;

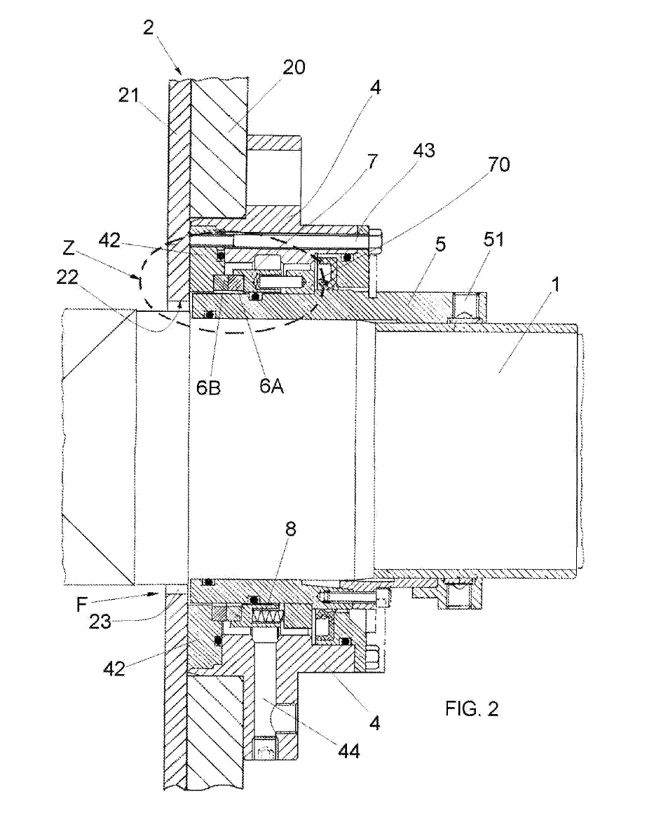

FIG. 2 is an axial cross-sectional view of a portion of a fluid mixer with a seal unit according to a first embodiment of the present invention;

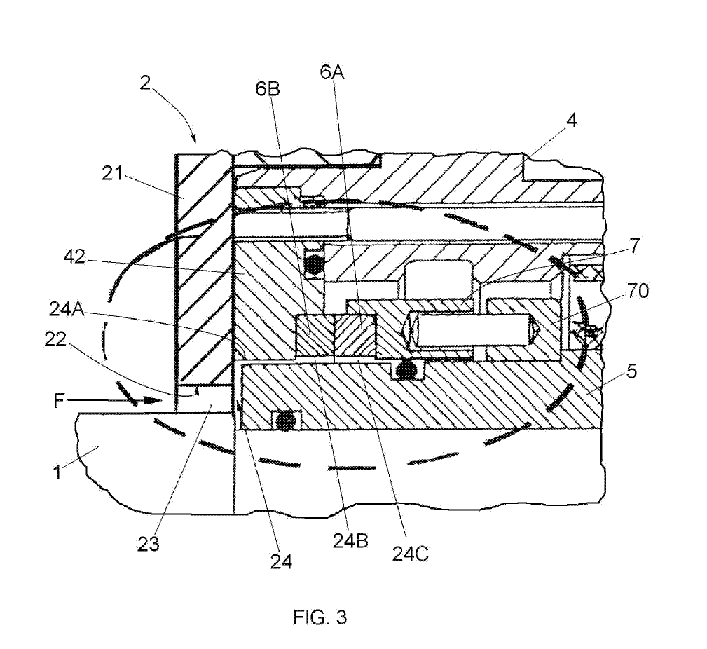

FIG. 3 is an enlarged detail contained in the broken ellipse Z of FIG. 2, which illustrates the inlet channel of the fluid and relevant chamber that contains the fluid;

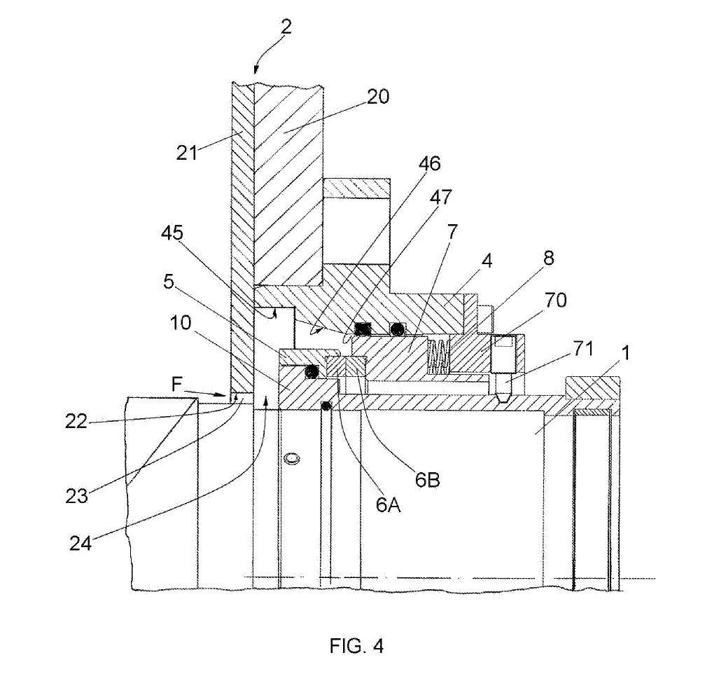

FIG. 4 is a partially interrupted cross-sectional axial view, which illustrates an improvement of the fluid mixer of FIG. 3; and

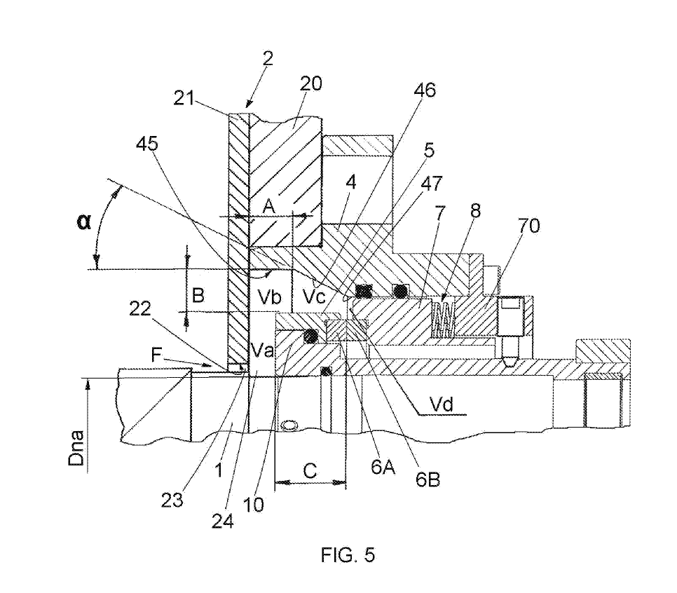

FIG. 5 is an enlarged detail of FIG. 4, which indicates the volumes of the chamber that contains the fluid coming from the inlet channel.

In order to eliminate the lubrication management problem, the applicant has tried to realise a seal unit as the one described in FIG. 2, in which identical or corresponding elements to the ones described in FIG. 1 are indicated with the same reference numerals, omitting their detailed description.

A sleeve (5) is joined to the shaft (1) by means of fixing pins (51). An annular slide (7) that slides in axial direction is mounted on the sleeve (5). The slide (7) is provided with a first seal ring (6A).

The first seal ring (6A) is moved in parallel direction to the rotational axis of the shaft (1) against a second seal ring (6B) provided on a fixed support (42) that is fixed to the support flange (4) with screws (43). Spring means (8) are positioned between a circular back element (70) joined to the sleeve (5) and the slide (7) that is provided with the first seal ring (6A). The spring means (8) are uniformly distributed on the circumference around the sleeve (5) in order to ensure the uniform thrust of the slide (7). In this way, the first seal ring (6A) is moved against the second seal ring (6B) in axial direction. The first seal ring (6A) rotates with the shaft (1) sliding on the second seal ring (6B) that remains fixed. The thrust force of the spring means (8) guarantees continuous sliding contact between the tracks of the seal rings (6A, 6B), thus obtaining the seal of the fluid that enters in the inlet channel (23) from the tank and flows towards the seal rings (6A, 6B).

It must be noted that the seal rings (6A, 6B) do not need lubrication with grease, thus eliminating the problems related with lubrication management.

As shown in FIGS. 2 and 3, according to the known technique the geometrical shape and arrangement of the fixed support (42) and the sleeve (5) have been designed in such a way to keep the fluid as far as possible from the sliding surfaces of the seal rings (6A, 6B). In fact, a chamber (24) is defined downstream the inlet channel (23), outside the tank, which is filled with fluid until contact with the seal rings (6A, 6B) is originated. To minimise the contact of the fluid with the seal rings (6A, 6B), the dimensions of the chamber (24) have been reduced as much as possible.

Moreover, the efficient cooling of the heat generated between the seal rings (6A, 6B) by friction must be guaranteed by providing conduits (44) (FIG. 2) in the support flange (4) for the cooling fluid of the seal rings (6A, 6B).

As shown in FIG. 3, the inlet channel (23) formed between the shaft (1) and the hole (22) of the coating wall (21) of the tank continues with the fluid chamber (24) with a first portion (24A) shaped as an “L” in axial cross-section, which is generated between the wall (21), the coupling (5) and the fixed support (42). The first portion of the chamber (24A) continues with:
a second portion of chamber (24B) formed between the coupling (5) and the second seal ring (6B), and
a third portion of chamber (24C) formed between the coupling (5) and the first seal ring (6A).

It must be noted that, due to low fluid volume/wet surface ratio, the fluid that enters the chamber (24) solidifies easily, with the following problems:
a) gluing of the sleeve (5) with the fixed support (42) because of material solidification in the first portion of the chamber (24A),
b) gluing of the sleeve (5) with the second seal ring (6B) because of material solidification in the second portion of the chamber (24B), and
c) gluing of the sleeve (5) with the first seal ring (6A) because of material solidification in the third portion of the chamber (24C).

When the mixer is restarted after a prolonged stop, the solidified fluid breaks easily in the first and second portion of the chamber (24A, 24B) between the sleeve (5) and the fixed support (42) provided with the second seal ring (6B). As a matter of fact, the sleeve (5) rotates with respect to the fixed support (42).

Nevertheless, the solidified fluid contained in the third portion of the chamber (24C) between the sleeve (5) and the first seal ring (6A) is not removed, because both the sleeve (5) and the first seal ring (6A) rotate with the shaft (1). Because of this, the solidified fluid in the third portion of the chamber (24C) blocks the axial elastic movement of the slide (7), favoured by the spring means (8), no longer ensuring contact between the sliding tracks of the seal rings (6A, 6B) and impairing the seal effect.

Once the material has solidified in the third portion of the chamber (24C), it is necessary to disassemble the seal unit, unblock it by removing the material deposited in the space (24C) and washing it, with environmental problems.

The inconvenience that is eliminated by the presence of the seal unit (that is the loss of fluid during mixing) is faced periodically because of the operations that are necessary to wash and repair the functionality of the seal. This problem occurs continuously, because of frequent stops and because of the short drying time of concrete.

The applicant has discovered that the said malfunctioning is determined by the small dimensions of the chamber (24). In fact, the shorter the distance between the surfaces of the chamber (24) (which can be considered as a cylindrical chamber, for purposes of simplicity), the larger the surfaces exposed to contact with the fluid will be in relation with the volume of the fluid contained in the chamber (24).

If we consider a solid, the smaller the dimensions of the solid, the larger the ratio between the surfaces that contain the solid and the volume of the solid will be, thus favouring the increase of surface forces with respect to the volume forces of the quantity of fluid contained in the chamber.

In view of the above, the tendency to dry that characterises the fluid in this small annular region will be higher than the situation in which the fluid volume tends to increase. The tendency to dry is proportional to the contact surfaces of the fluid, being connected to heat exchange through contact surfaces. The heat generation connected with the transformations of the fluid is proportional to the volume (to the mass of the fluid contained in the chamber (24)); the capacity to exchange heat is proportional to the surfaces of the chamber (24). If the surface/volume ratio tends to increase with smaller dimensions of the chamber (24), the tendency to dry of the fluid tends to increase (heat exchange through surfaces increases with respect to the internally generated one), together with the fluid adhesion to the same surfaces.

In view of the above, the applicant has concluded that the volume of fluid in the chamber (24) upstream the seal rings (6A, 6B) must be sufficiently big to avoid the tendency of the fluid to dry and adhere to the surfaces.

In order to achieve the said result, the applicant has modified the seal unit of FIG. 2 and devised the improved seal unit illustrated in FIGS. 4 and 5.

According to the improved seal unit, the rotary shaft (1) has a sleeve with collar (10) arranged at a certain distance from the wall (21) of the tank. The collar of the sleeve (10) is fitted with a coupling (5) provided with a first seal ring (6A).

A circular slide (7) is fitted and axially slides inside the flange (4) fixed to the support wall (20) of the tank. The slide (7) is provided with the second seal ring (6B) that moves against the first seal ring (6A). The slide (7) is pushed towards the first seal ring (6A) by a spring (8) situated between the slide (7) and a back element (70) fitted to the fixed flange (4).

It must be noted that the first seal ring (6A) is mounted at the end of the coupling (47) at a distance from the coating wall (21) of the tank. The second seal ring (6B) is mounted at the end of the slide (7) near the coating wall (21) of the tank.

The distribution of the elastic force along the circumference of the slide (7) is another critical element for the following parameters:
a) the elastic force must be sufficiently high to generate efficacious pressure between the sliding tracks of the seal rings (6A, 6B) in order to guarantee the fluid seal;
b) the elastic force must be equally distributed on the circumference of the slide (7) to guarantee continuous uniform contact also in the presence of misalignment between the axis of the seal rings (6A, 6B) and the axis of the hole that houses the seal support flange; this problem can be solved by providing a series of springs (8) on the circumference of the slide (7) that ensure the amplification of the elastic thrust and the equal distribution of the same elastic force on the entire circumference of the slide (7).

The seal unit is pre-assembled by means of four pre-load pins (71) at 90° that block the element (70) on the sleeve of the collar (10) to compress the spring (8). During the assembly of the seal unit on the machine, once the unit is fitted to the coating wall (20) and the shaft (1) by means of nuts and pins, the four pre-load pins (71) are loosened to release the element (70) from the sleeve with collar (10) joined to the shaft (1).

The internal surface of the fixed flange (4) is suitably shaped in order to maximise the fluid chamber (24). In fact, starting from the wall (21) of the tank, the internal surface of the flange (4) has a cylindrical hole (45) with larger diameter that continues with a truncated-conical hole (46) with decreasing diameter, which ends with a circular hole (47) in which the slide (7) is mounted and slides axially.

As shown in FIG. 5, the fluid chamber (24) provides for:
a first toroidal volume (Va) defined between the wall of the tank (21) and the end of the sleeve with collar (10) of the shaft and the coupling (5) mounted on the sleeve with collar (10),
a second toroidal volume (Vb) defined between the wall (21) of the tank, the cylindrical hole (45) with larger diameter of the flange (4) and the coupling (5),
a third truncated conical toroidal volume (Vc) defined between the truncated conical hole (46) of the flange (4), the coupling (5) and the first seal ring (6A),
a fourth toroidal volume (Vd) defined between the cylindrical hole (47) with lower diameter of the flange, the end of the slide (7) and the second seal ring (6B).

The volumes (Va, Vb, Vc) are in contact with the rotary part composed of the shaft (1), the sleeve with collar (10), the coupling (5) and the first seal ring (6A). Therefore, the fluid contained in the volumes (Va, Vb, Vc) is removed easily. The critical part is represented by the fluid contained in the volume (Vd).

A series of tests performed with different dimensions of the fluid volume (Va, Vb, Vc, Vd) that reaches the seal rings (6A, 6B) has allowed to define the following measures:

A=length of the cylindrical hole (45) of the flange (4);

B=distance between the external surface of the coupling (5) and the surface of the cylindrical hole (45) of the flange (4);

C=distance from the end of the coupling (5) near the wall of the tank and the contact surface of the first seal ring (6A) at a distance from the wall of the tank;

Dna=nominal diameter of the shaft (1); and

α=coning angle of the truncated conical hole (46) of the flange (4).

In particular:
A, B C and α define the fluid volume in the chamber (24) upstream the seal rings (6A, 6B);
C defines the contact surface between the rotary part (5, 6A) and the fluid, through which, when the shaft is restarted, the transmitted torque breaks and drives the solidified fluid contained in the volume (Va, Vb, Vc, Vd);
during the rotation of the rotary part (5, 6A) the angle α favours the complete filling of the fluid inside the chamber (24) before the two seal rings (6A, 6B).

According to the present invention, the chamber (24) generated by the volumes (Va, Vb, Vc, Vd) must be sufficiently large to favour a reduced adhesion of the fluid contained inside the chamber to the surfaces of the same chamber, with consequent lower drying. Through suitable dimensioning of the rotary surfaces that are proportional to distance (C), (when the shaft (1) is restarted), the transported running torque crushes the solidified product (due to its lower mechanical resistance) and, consequently, starts the shaft.

After starting, the new fluid that enters in the inlet channel (23) and the chamber (24) is mixed with the dry material in the chamber (24) (which was crushed when the shaft was started) and is part of the finished product.

Such a solution eliminates the problem experienced when the material is glued on the seal ring provided on the slide (7), which prevents the axial sliding of the slide produced by the springs (8) and the contact of the sliding tracks of the seal rings (6A, 6B).

Based on experimental results, the following constructive limits have been determined to avoid the aforementioned gluing phenomena.
α>15 angular degrees;
   A/Dna >0.1;
   B/Dna >0.1;
   C/Dna >0.2.

Numerous variations and modifications can be made to the present embodiments of the invention by an expert of the field, while still falling within the scope of the invention as claimed in the enclosed claims.

1. Fluid mixer comprising:
a tank used to contain the fluid to be mixed,
a rotary shaft (1) that goes through a hole (22) obtained on the wall (2) of the tank, which generates a channel (23), between the external surface of the shaft (1) and the perimeter of the hole (22) of the wall of the tank, in which the fluid enters from the tank towards a chamber (24) outside the tank, in which the shaft (1) rotates, and
a seal unit designed to prevent leakage of the fluid from the chamber (24) outside,
characterised by the fact that
the said seal unit comprises a first seal ring (6A) joined to the rotary shaft (1) and a second seal ring (6B) joined to a support flange (4) fixed to the support wall (20) of the tank, in such a way that the first seal ring (6A) slides in close contact with the second seal ring (6B) preventing the passage of fluid from the chamber (24) outside.

2. Fluid mixer as claimed in claim 1, characterised in that at least one of the two seal rings (6A, 6B) is stressed in axial direction by spring means (8) towards the other seal ring in such a way to ensure continuous uniform sliding contact between them.

3. Fluid mixer as claimed in claim 2, characterised in that:
the first seal ring (6A) is held by a coupling (5) fixed to a coupling with collar (10) joined to the shaft (1),
the second seal ring (6B) is held by a circular slide (7) mounted with possibility of sliding in axial direction inside the support flange (4), and
the spring means (8) are positioned between the slide (7) and a back element (70) fixed to the support flange (4).

4. Fluid mixer as claimed in claim 3, characterised in that the first seal ring (6A) is arranged at the end of the coupling (5) in a distal position with respect to the coating wall (21) of the tank.

5. Fluid mixer as claimed in claim 3 or 4, characterised in that the second seal ring (6B) is arranged at the end of the slide (7) in proximal position with respect to the coating wall (21) of the tank.

6. Fluid mixer as claimed in any of claims 3 to 5, characterised in that, starting from the wall (2) of the tank, the support flange (4) has a cylindrical hole (45) with higher diameter that continues with a truncated-conical hole (46) with decreasing diameter that ends in a cylindrical hole with lower diameter (47) in which the slide (7) that holds the second seal ring (6B) is mounted.

7. Fluid mixer as claimed in claim 6, characterised in that:
the ratio (A/Dna) between the length (A) in axial direction of the cylindrical hole with higher diameter (45) of the flange (4) and the nominal diameter (Dna) of the shaft (1) is higher or equal to 0.1; and
the ratio (B/Dna) between the distance (B) in radial direction between the coupling (5) that holds the first seal ring (6A) and the cylindrical hole with higher diameter (45) of the flange (4) and the nominal diameter (Dna) of the shaft (1) is higher or equal to 0.1.

8. Fluid mixer as claimed in claim 6 or 7, characterised in that the truncated conical hole (46) of the flange (4) has a coning angle (α) higher or equal to 15°.

9. Fluid mixer as claimed in any of the above claims 3 to 8, characterised in that a length (C) in axial direction is defined between the end of the coupling (5) in proximal position with respect to the wall of the tank and the contact end of the first seal ring (6A) at a distance from the wall of the tank, and the ratio (C/Dna) between the said length (C) and the nominal diameter (Dna) of the shaft is equal or higher than 0.2.
